(19) United States
(12) Patent Application Publication
(10) Pub. No.: US 2014/0197216 A1
(43) Pub. Date: Jul. 17, 2014

(54) STRINGED INSTRUMENT PICK HOLDER ACCESSORY

(71) Applicant: TIMOTHY JOHN BORTREE, Rancho Santa Fe, CA (US)

(72) Inventor: TIMOTHY JOHN BORTREE, Rancho Santa Fe, CA (US)

(21) Appl. No.: 13/741,379

(22) Filed: Jan. 14, 2013

(51) Int. Cl. G10D 3/16

(52) U.S. Cl. CPC G10D 3/163
USPC 224/267

(57) ABSTRACT

A stringed instrument pick holder accessory suitable for wearing around at least a portion of a human body part includes an accessory body defining an enclosure within which the human body part portion fits when the accessory is worn; and at least one stringed instrument pick removably attached to the accessory body, such that the pick is detachable from the accessory body; wherein the accessory body includes a loop having a fixed length; the accessory body includes a linear extension that extends radially outward from the accessory body, the linear extension including a flexible strap formed of a stretchable material; a body of the pick includes a bore through which a distal end of the linear extension passes; the pick body further includes a breakaway feature including a weakened portion of the pick body adjacent the bore; and the weakened portion includes a separable portion extending substantially from the bore to an outer edge of the pick body, the separable portion including a tapered cut extending from a wide end of the cut, the wide end being adjacent the bore, to a narrow end of the cut, the narrow end being adjacent the outer edge.

### CROSS REFERENCE TO RELATED APPLICATIONS

The present application claims priority from U.S. Provisional Application No. 61/586,785 filed Jan. 14, 2012 and U.S. Provisional Application No. 61/694,233 filed Aug. 28, 2012, the entire disclosures of which are hereby incorporated by reference herein.

### FIELD OF THE INVENTION

The present invention relates generally to music instrument accessories, and more particularly to stringed instrument pick holders.

### BACKGROUND OF THE INVENTION

Many guitar players use a pick when playing a stringed instrument, such as, for example, a guitar, to accurately or easily pick the instrument's strings, or to pick the strings in a specific way.

Frequently, some stringed instrument players will use two or more different types of picks during a performance. Often, the performance must be halted or delayed unless the one or more alternate picks are readily available.

Frequently, some stringed instrument players will drop the pick when playing. Many times the pick will fall onto the floor. If the stringed instrument has a hollow body, the pick may fall into the body. In many such situations, retrieving the pick would disrupt the musical performance. Often, the piece must be halted or delayed for an undesirable period of time unless a replacement pick is readily available.

### SUMMARY OF THE INVENTION

Accordingly, one or more aspects of the present invention include providing a stringed instrument pick holder accessory. More particularly, the present invention preferably includes a stringed instrument pick holder accessory suitable for wearing around at least a portion of a human body part, such as, for example, a wrist or neck, the accessory preferably including a body defining an enclosure within which the body part portion fits when the accessory is so worn, the accessory preferably further including at least one stringed instrument pick attached to the accessory body.

Further particularly, embodiments of the present invention can include one or more of the following features, in any suitable combination or permutation:

(1) at least a portion of the accessory body is rigid;

(2) at least a portion of the accessory body is flexible;

(3) at least a portion of the accessory body is selected from the group including a loop, a strap, a band, a chain, a rope, a string, a bracelet, and a necklace;

(4) at least a portion of the accessory body has a fixed length;

(5) at least a portion of the accessory body has a length allowing the wearer use of the pick to play a stringed instrument without removing the accessory from the wearer or removing the pick from the accessory;

(6) at least a portion of the accessory body has at least one adjustable dimension (for example, an adjustable length);

(7) at least a portion of the accessory body is flexible enough to allow the wearer use of the pick to play a stringed instrument while flexing such portion without removing the accessory from the wearer or removing the pick from the accessory;

(8) at least a portion of the accessory body is stretchable enough to allow the wearer use of the pick to play a stringed instrument while stretching such portion without removing the accessory from the wearer or removing the pick from the accessory;

(9) at least a portion of the pick is detachable from the accessory body;

(10) at least a portion of the pick is removably attached to the accessory body;

(11) at least a portion of the pick includes a bore, and the accessory body passes through the bore;

(12) at least a portion of the pick including at least one breakaway feature, the breakaway feature preventing the detachment of the pick from the accessory body under forces applied to the feature during casual wearing of the accessory, but allowing at least a portion of the pick to be detached from the accessory body substantially at the location of the feature by the application of a force exceeding such forces applied to the feature during casual wearing of the accessory;

(13) at least a portion of the pick including at least one breakaway feature, the breakaway feature including at least one weakened portion of a pick body, such that if a force greater than a maximum force that can be withstood by the weakened portion is applied to the weakened portion, the weakened portion fails and such failure allows the pick to be detached from the accessory body substantially at the location of the weakened portion by passing the accessory body through the weakened portion;

(14) at least a portion of the pick including at least one breakaway feature, the breakaway feature including at least one separable portion of a pick body, such that if a force greater than a maximum force that prevents the separable portion from separating is applied to the separable portion, the separable portion separates and such separation allows the pick to be detached from the accessory body substantially at the location of the separable portion by passing the accessory body through the separated separable portion;

(15) at least a portion of the pick includes a bore, and the accessory body passes through the bore, and at least a portion of the pick has at least one breakaway feature, the breakaway feature including a weakened portion of the pick body adjacent the bore, such weakened portion extending substantially from the bore to an outer edge of the pick body, such that if a force greater than a maximum force that can be withstood by the weakened portion is applied to the weakened portion, the weakened portion fails and such failure allows the pick to be detached from the accessory body substantially at the location of the weakened portion by passing the accessory body through the weakened portion;

(16) at least a portion of the pick includes a bore, and the accessory body passes through the bore, and at least a portion of the pick has at least one breakaway feature, the breakaway feature including a weakened portion of the pick body adjacent the bore, such weakened portion including a separable portion of the pick body, such separable portion extending substantially from the bore to an outer edge of the pick body, such that if a force greater than a maximum force that prevents the separable portion from separating is applied to the separable portion, the separable portion separates and such separation allows the pick to be detached from the accessory body substantially at the location of the separable portion by passing the accessory body through the separated separable portion;

(17) at least a portion of the pick has at least one breakaway feature, the breakaway feature including at least one weakened portion of the pick body, such weakened portion including but not being limited to one or more of the following: (a) one or more perforations extending across at least a portion of the pick, (b) one or more scored sections extending across at least a portion of the pick, (c) one or more perforations extending substantially from a bore of the pick (e.g., through which the accessory body passes when the pick is attached to the accessory body) to an outer edge of the pick, (d) a separation (e.g., a slot) of the pick body, the separation having overlapping edges, the separation extending from a bore of the pick (e.g., through which the accessory body passes when the pick is attached to the accessory body) to an outer edge of the pick, (e) a separation (e.g., a slot) of the pick body, the separation having sides (preferably cushioned) that are biased toward one another, the separation extending from a bore of the pick (e.g., through which the accessory body passes when the pick is attached to the accessory body) to an outer edge of the pick, and (f) a tapered cut (e.g., wedge cut) extending from a wide end (of the cut) adjacent a bore of the pick to a narrow end (of the cut) adjacent an outer edge of the pick;

(18) at least a portion of the pick has at least one breakaway feature, the breakaway feature including an extension (e.g., a tab) of the pick body, a connection of the extension to the pick body including at least one scoring feature having a weaker tensile structure than a main body of the pick or a body of the extension, wherein the extension body is attached to the accessory body, such that when the main body of the pick is pulled in a direction away from the accessory body and accordingly tension is applied to the scoring feature as the extension body remains held to the accessory body by the attachment of the extension body to the accessory body, the scoring feature breaks and the main body of the pick is thereby detached from the accessory body substantially at the location of the scoring feature;

(19) at least a portion of the pick has at least one breakaway feature, the breakaway feature including an extension (e.g., a tab) extending from an edge of the pick, the extension's connection to the edge of the pick including at least one perforation feature having a weaker tensile structure than a main body of the pick or a body of the extension, wherein the body of the extension is attached to the accessory body, such that when the main body of the pick is pulled in a direction away from the accessory body and accordingly tension is applied to the perforation feature as the body of the extension remains held to the accessory body by the attachment of the body of the extension to the accessory body, the perforation feature breaks and the main body of the pick is thereby detached from the accessory body substantially at the location of the perforation feature;

(20) at least a portion of the accessory body includes one or more attachment modules, each having at least one attachment receptacle (e.g., a slot) into which at least a portion of one or more picks can be removably secured;

(21) at least a portion of the accessory body includes one or more attachment modules, each having at least one attachment receptacle (e.g., a slot) into which at least a portion of one or more picks can be removably secured, the attachment receptacle being a receptacle (e.g., a slot) having at least two opposing sides biased toward one another with a compression force strong enough to hold at least a portion of a pick between the sides against gravity and reasonable centrifugal and other forces experienced by the pick during casual wearing of the accessory, but weak enough to allow the pick to be removed from the receptacle by a pulling forced exertable by a person, and to allow the pick to be inserted into the receptacle by a pushing force exertable by a person;

(22) at least a portion of the accessory body includes at least one extension (e.g., a linear extension) extending radially from the accessory body, the extension having at least one distal end, the pick being attached to the distal end;

(23) at least a portion of the accessory body includes at least one extension (e.g., a linear extension) extending radially from the accessory body, the extension having at least one distal end, the pick being attached to the distal end, the extension having an adjustable length;

(24) at least a portion of the accessory body includes at least one extension (e.g., a linear extension) extending radially from the accessory body, the extension having at least one distal end, the pick being attached to the distal end, the extension being retractable; and

(25) at least a portion of the accessory body includes at least one extension (e.g., a linear extension) extending radially from the accessory body, the extension having at least one distal end, the pick being attached to the distal end, the extension having a length permitting use of the pick to play a stringed instrument while wearing the accessory with the pick attached to the accessory body.

It should be understood that many types of breakaway features, weakened portions, separable portions, and other aspects of the invention are contemplated by the present invention, and that such aspects of the invention are not limited to any specific descriptions provided herein.

It should further be understood that the present invention can additionally include one or more elements and/or features for enabling one or more parts of the accessory body to be opened and closed to ease putting on and/or taking off the accessory.

It should be understood that one or more parts of the accessory can be movably attached to one or more other parts of the accessory, to enhance comfort, appearance, usability or other aspects of the accessory.

It should be further understood that one or more parts of the present invention can be formed from any suitable materials and any suitable shapes. It should be further understood that one or more parts of the present invention can be provided in any suitable or desirable colors or textures. It should be further understood that one or more parts of the present invention can be provided with any suitable or desirable designs, text, or other visual images thereon.

### BRIEF DESCRIPTION OF THE DRAWINGS

FIG. 1 illustrates a stringed instrument pick holder accessory in accordance with one or more aspects of the invention.

FIG. 2 illustrates a plurality of perforations (extending across a pick body) of a weakened portion of a breakaway feature of a stringed instrument pick holder accessory in accordance with one or more aspects of the invention.

FIG. 3 illustrates a plurality of perforations (extending from a bore to an outer edge of a pick body) of a weakened portion of a breakaway feature of a stringed instrument pick holder accessory in accordance with one or more aspects of the invention.

FIG. 4 illustrates a plurality of scored sections of a weakened portion of a breakaway feature of a stringed instrument pick holder accessory in accordance with one or more aspects of the invention.

FIG. 5 illustrates a pick body separation (having overlapping edges) of a weakened portion of a breakaway feature of a stringed instrument pick holder accessory in accordance with one or more aspects of the invention.

FIG. 6 illustrates a pick body separation (having compressively biased sides) of a weakened portion of a breakaway feature of a stringed instrument pick holder accessory in accordance with one or more aspects of the invention.

FIG. 7 illustrates a pick body extension (having a scored connection to a pick main body) of a breakaway feature of a stringed instrument pick holder accessory in accordance with one or more aspects of the invention.

FIG. 8 illustrates a pick body extension (having a perforated connection to a pick main body) of a breakaway feature of a stringed instrument pick holder accessory in accordance with one or more aspects of the invention.

FIG. 9 illustrates an attachment module of an accessory body of a stringed instrument pick holder accessory in accordance with one or more aspects of the invention.

### DETAILED DESCRIPTION OF THE INVENTION

Preferred embodiments of the present invention will now be described in detail.

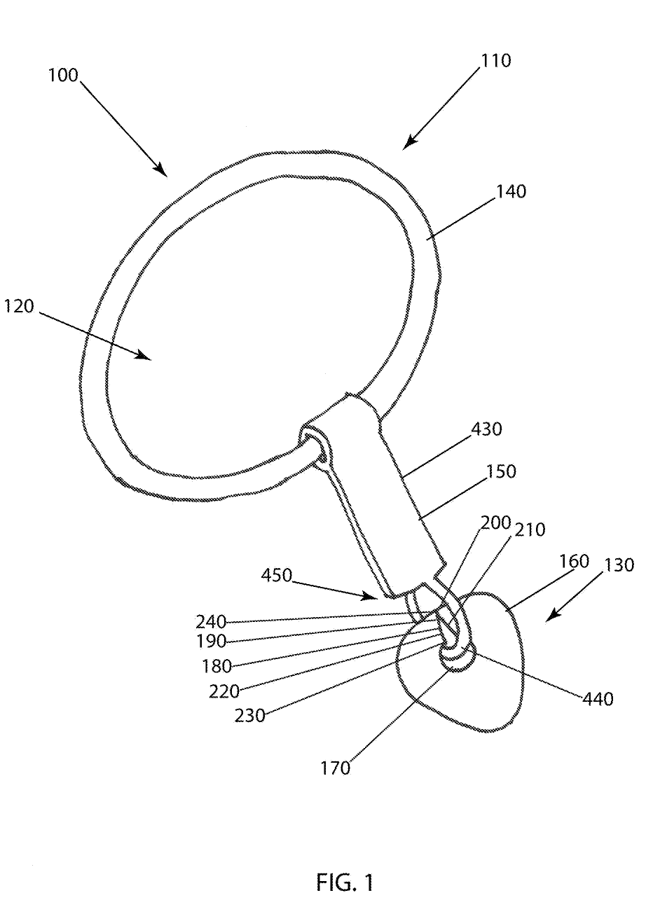

Referring now to FIG. 1, a first preferred embodiment of the present invention includes a stringed instrument pick holder accessory 100 suitable for wearing around at least a portion of a human body part, such as, for example, a wrist or neck. The accessory 100 includes a body 110 defining an enclosure 120 within which the body part portion fits when the accessory 100 is so worn. The accessory 100 further includes at least one stringed instrument pick 130. As described hereinbelow, the pick 130 is removably attached to the accessory body 110, such that the pick 130 is detachable from the accessory body 110.

Further referring to FIG. 1, the accessory body 110 includes a rigid loop 140 having a fixed length. In embodiments in which the accessory 100 is suitable for wearing around a wrist, the length of the rigid loop 140 is long enough to surround the wrist of the wearer. In embodiments in which the accessory 100 is suitable for wearing around a neck, the length of the rigid loop 140 is long enough to surround the neck of the wearer. It should be understood that the rigid loop 140 can additionally include one or more elements (not shown) and/or features (not shown) for enabling the rigid loop 140 to be opened and closed to ease putting on and/or taking off the accessory 100, such as, for example, a latch, clasp, hook, or the like.

Further referring to FIG. 1, the accessory body 110 includes a linear extension 430 that extends radially outward from the accessory body 110. The linear extension 430 includes a flexible strap 150 having an adjustable length. (It should be understood that the flexible strap 150 can be movably attached to the rigid loop 140 such that a proximal end 450 of the strap 150 can be moved along the rigid loop 140. It should also be understood that the flexible strap 150 can be retractably attached to the rigid loop 140 by way of a retraction mechanism (not shown) such that the strap 150 is biased toward a retracted state but can be extended from the retracted state.) The flexible strap 150 is formed from a stretchable material such as, for example, elastic. The flexible strap 150 is flexible enough to allow the wearer use of the pick 130 to play a stringed instrument (not shown) while flexing the strap 150 without removing the accessory 100 from the wearer or removing the pick 130 from the accessory 100. Further, the flexible strap 150 is stretchable enough to allow the wearer use of the pick 130 to play a stringed instrument (not shown) while stretching the strap 150 without removing the accessory 100 from the wearer or removing the pick 130 from the accessory 100.

Further referring to FIG. 1, the pick 130 includes a pick body 160 that includes a bore 170 through which a distal end 440 of the linear extension 430 of the accessory body 110 passes. The pick body 160 further includes a breakaway feature 180. The breakaway feature 180 prevents the detachment of the pick 130 from the accessory body 110 under forces applied to the feature 180 during casual wearing of the accessory 100, but allowing at least a portion of the pick 130 to be detached from the accessory body 110 substantially at the location of the feature 180 by the application of a force exceeding such forces applied to the feature 180 during casual wearing of the accessory 100.

The breakaway feature 180 includes a weakened portion 190 of the pick body 160 adjacent the bore 170, such that if a force greater than a maximum force that can be withstood by the weakened portion 190 is applied to the weakened portion 190, the weakened portion 190 fails and such failure allows the pick 130 to be detached from the accessory body 130 substantially at the location of the weakened portion 190 by passing the accessory body 130 through the weakened portion 190. The weakened portion 190 extends substantially from the bore 170 to an outer edge 200 of the pick body 160.

The weakened portion 190 includes a separable portion 210, such that if a force greater than a maximum force that prevents the separable portion 210 from separating is applied to the separable portion 210, the separable portion 210 separates and such separation allows the pick 130 to be detached from the accessory body 110 substantially at the location of the separable portion 210 by passing the accessory body 110 through the separated separable portion 210. The separable portion 210 extends substantially from the bore 170 to an outer edge 200 of the pick body 160. The separable portion 210 includes a tapered cut 220 extending from a wide end 230 (of the cut 210) adjacent the bore 170 to a narrow end 240 (of the cut 210) adjacent the outer edge 200.

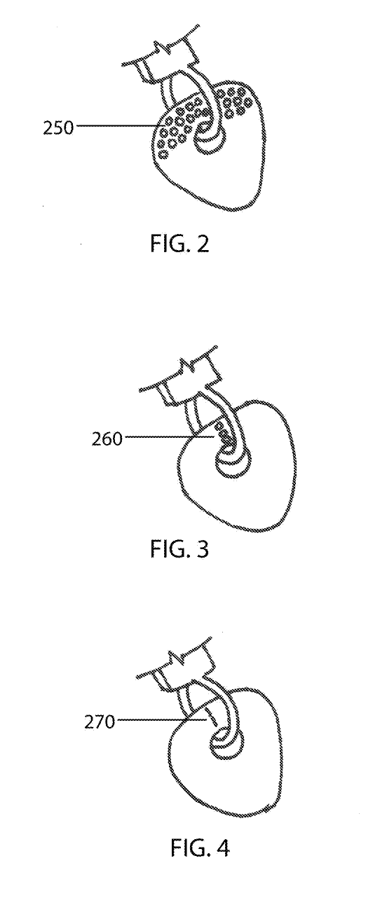

Referring now also to FIG. 2, in an alternate preferred embodiment, the weakened portion 190 includes a plurality of perforations 250 extending across the pick body 160.

Referring now also to FIG. 3, in an alternate preferred embodiment, the weakened portion 190 includes a plurality of perforations 260 extending from the bore 170 to the outer edge 200 of the pick body 160.

Referring now also to FIG. 4, in an alternate preferred embodiment, the weakened portion 190 includes a plurality of scored sections 270 extending across the pick body 160.

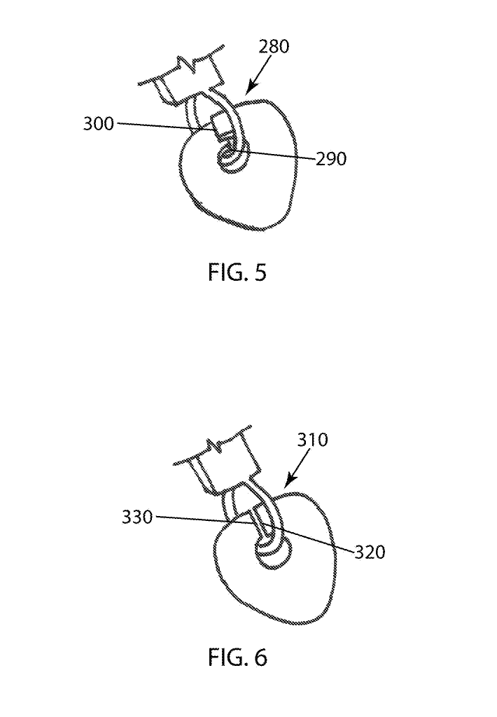

Referring now also to FIG. 5, in an alternate preferred embodiment, the weakened portion 190 includes a separation 280 of the pick body 160, the separation having a first edge 290 and a second edge 300 that overlap one another, the separation 280 extending from the bore 170 to the outer edge 200 of the pick body 160.

Referring now to FIG. 6, in an alternate preferred embodiment, the weakened portion 190 includes a separation 310 of the pick body 160, the separation 310 having a first side 320 and a second side 330 (each of which is preferably cushioned). The first side 320 and second side 330 are biased toward a closed position (shown) in which the first side 320 and the second side 330 are substantially closed against one another. The separation 310 extends from the bore 170 to the outer edge 200 of the pick body 160.

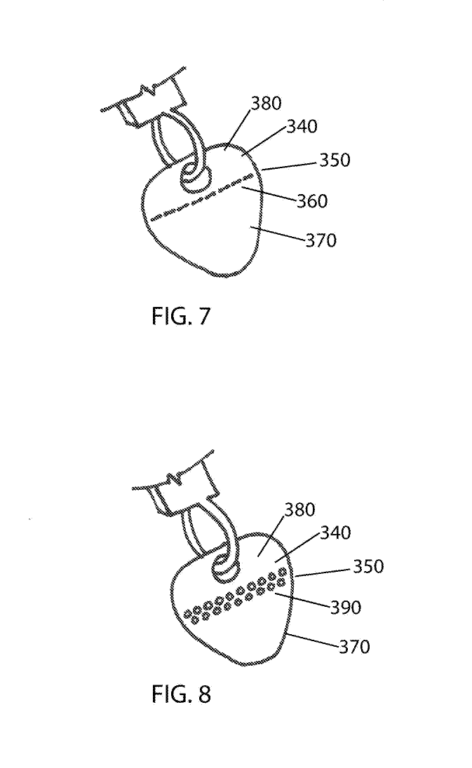

Referring now to FIG. 7, in an alternate preferred embodiment, the breakaway feature 180 includes an extension 340 of the pick body 160, a connection 350 of the extension 340 to the pick body 160 including a scoring feature 360 having a weaker tensile structure than a main body 370 of the pick 130 or a body 380 of the extension 340, wherein the extension body 380 is attached to the accessory body 110, such that when the main body 370 of the pick 130 is pulled in a direction away from the accessory body 110 and accordingly tension is applied to the scoring feature 360 as the extension body 380 remains held to the accessory body 110 by the attachment of the extension body 380 to the accessory body 110, the scoring feature 360 breaks and the main body 370 of the pick 130 is thereby detached from the accessory body 110 substantially at the location of the scoring feature 360.

Referring now to FIG. 8, in an alternate preferred embodiment, the breakaway feature 180 includes an extension 340 of the pick body 160, a connection 350 of the extension 340 to the pick body 160 including a perforation feature 390 having a weaker tensile structure than a main body 370 of the pick 130 or a body 380 of the extension 340, wherein the extension body 380 is attached to the accessory body 110, such that when the main body 370 of the pick 130 is pulled in a direction away from the accessory body 110 and accordingly tension is applied to the perforation feature 390 as the extension body 380 remains held to the accessory body 110 by the attachment of the extension body 380 to the accessory body 110, the perforation feature 390 breaks and the main body 370 of the pick 130 is thereby detached from the accessory body 110 substantially at the location of the perforation feature 390.

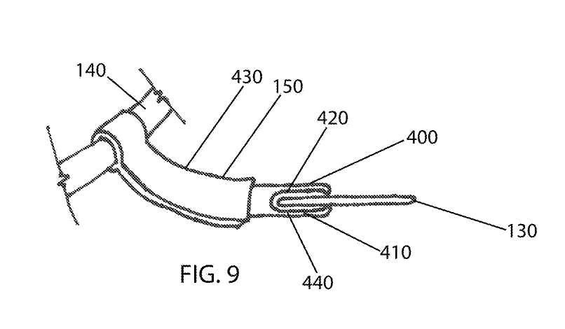

Referring now to FIG. 9, in an alternate preferred embodiment, the accessory body 110 includes an attachment module 400. The attachment module 400 includes an attachment receptacle 410 into which the pick 130 can be removably secured. The attachment receptacle 410 includes a first side 420 and a second side 430 that opposed one another. The first side 420 and the second side 430 are biased toward one another under a compression force strong enough to hold the pick 130 between the first side 420 and the second side 440 against gravity and reasonable centrifugal and other forces experienced by the pick 130 during casual wearing of the accessory 100, but weak enough to allow the pick 130 to be removed from the attachment receptacle 410 by a pulling forced exertable by a person, and to allow the pick 130 to be inserted into the attachment receptacle 410 by a pushing force exertable by a person.

What is claimed is:

1. A stringed instrument pick holder accessory suitable for wearing around at least a portion of a human body part, comprising:
an accessory body defining an enclosure within which the human body part portion fits when the accessory is worn; and
at least one stringed instrument pick removably attached to the accessory body, such that the pick is detachable from the accessory body; wherein
the accessory body includes a loop having a fixed length;
the accessory body includes a linear extension that extends radially outward from the accessory body, the linear extension including a flexible strap formed of a stretchable material;
a body of the pick includes a bore through which a distal end of the linear extension passes;
the pick body further includes a breakaway feature including a weakened portion of the pick body adjacent the bore; and
the weakened portion includes a separable portion extending substantially from the bore to an outer edge of the pick body, the separable portion including a tapered cut extending from a wide end of the cut, the wide end being adjacent the bore, to a narrow end of the cut, the narrow end being adjacent the outer edge.
